(19) United States
(12) Patent Application Publication
(10) Pub. No.: US 2010/0153124 A1
(43) Pub. Date: Jun. 17, 2010

(54) AUTOMATED DATA ANALYSIS AND RECOMMENDATION SYSTEM AND METHOD

(76) Inventors: ARUNDAT MERCY DASARI, Bangalore (IN); Amit Vikram, Bangalore (IN); Sumanta Basu, Bangalore (IN)

Correspondence Address: GLOBAL IP SERVICES, PLLC, 10 CRESTWOOD LANE, NASHUA, NH, 03062, US

(21) Appl. No.: 12/333,332

(22) Filed: Dec. 12, 2008

(51) Int. Cl. G06Q 99/00

(52) U.S. Cl. 705/1.1

(57) ABSTRACT

An automated data analysis and recommendation system and method are disclosed. In one embodiment, a method of providing a process cockpit includes configuring a definition of requirements through a user interface, analyzing extracted process data and extracting information from the analyzed process data, via a computer, based on the requirements, generating, via the computer, recommended actions based on the information, and determining, via the computer, a related series of interdependent actions and an impact on the related series of interdependent actions based on the particular recommended action for each recommended action. Further, the method includes displaying, via the computer, the information, the recommended actions, the related series of interdependent actions and the impact on the related series of interdependent actions based on the particular recommended action, and configuring, via the computer, the process cockpit to allow at least one business scenario mapping based on the information and a selected recommended action.

### FIELD OF TECHNOLOGY

Embodiments of the present invention relate to the field of business process outsourcing. More particularly, embodiments of the present invention relate to a system and method for automated data analysis and recommendation.

### BACKGROUND

A business process generates process data on a real time basis. One example of process data in a financial business process is an overview of the financial performance with focus on the cash flow for a specified time period. The process data is the actual cash flow data for the specified time period. There exists a business need to further process this data to extract meaningful information, which may be used in various decision-making activities. For example, if the cash flow shows a downward trend, then the process data needs to be analyzed to identify the underlying reasons responsible for the downward trend. The downward trend in the cash flow, for example, may be due to failure to initiate invoices in time and/or incorrect invoices being generated in the business process. The process owners can then take necessary actions based on the process data and the analyzed information to rectify the situation and achieve business and process objectives.

### BRIEF DESCRIPTION OF THE DRAWINGS

Embodiments of the present invention are illustrated by way of examples and not limited to the figures of the accompanying drawings, in which like references indicate similar elements and in which:

FIG. 1 illustrates a block diagram showing a process cockpit which is used in conjunction with business process outsourcing services, according to one embodiment;

FIG. 2 illustrates a block diagram showing a recommended actions method, according to one embodiment;

FIG. 3 illustrates various modules associated with the process cockpit of FIG. 1, according to one embodiment;

FIG. 4 illustrates a block diagram showing a user profile based display system, according to one embodiment;

FIG. 5 illustrates a block diagram showing various display system dashboards, according to on embodiment;

FIG. 6 illustrates a block diagram showing a configuration system associated with the process cockpit of FIG. 1, according to one embodiment;

FIG. 7 illustrates an exemplary process configuration screenshot, according to one embodiment;

FIG. 8 illustrates another exemplary process configuration screenshot, according to one embodiment;

FIG. 9 illustrates an exemplary administrative configuration screenshot, according to one embodiment;

FIG. 10 illustrates another exemplary administrative configuration screenshot, according to one embodiment;

FIG. 11 illustrates a process flow chart showing a method of providing the process cockpit which is used in conjunction with the business process outsourcing services, according to one embodiment;

FIG. 12 illustrates a diagrammatic system view of a data processing system in which any of the embodiments disclosed herein may be performed, according to one embodiment;

FIGS. 13A-13F illustrate exemplary screenshots showing automated data analysis through the process cockpit, according to one embodiment; and

FIG. 14 illustrates an exemplary screenshot showing recommended actions generated to resolve any particular business scenario in the autonomic business process platform, according to one embodiment.

Other features of the present embodiments will be apparent from the accompanying drawings and from the detailed description that follow.

### DETAILED DESCRIPTION

An automated data analysis and recommendation system and method are disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

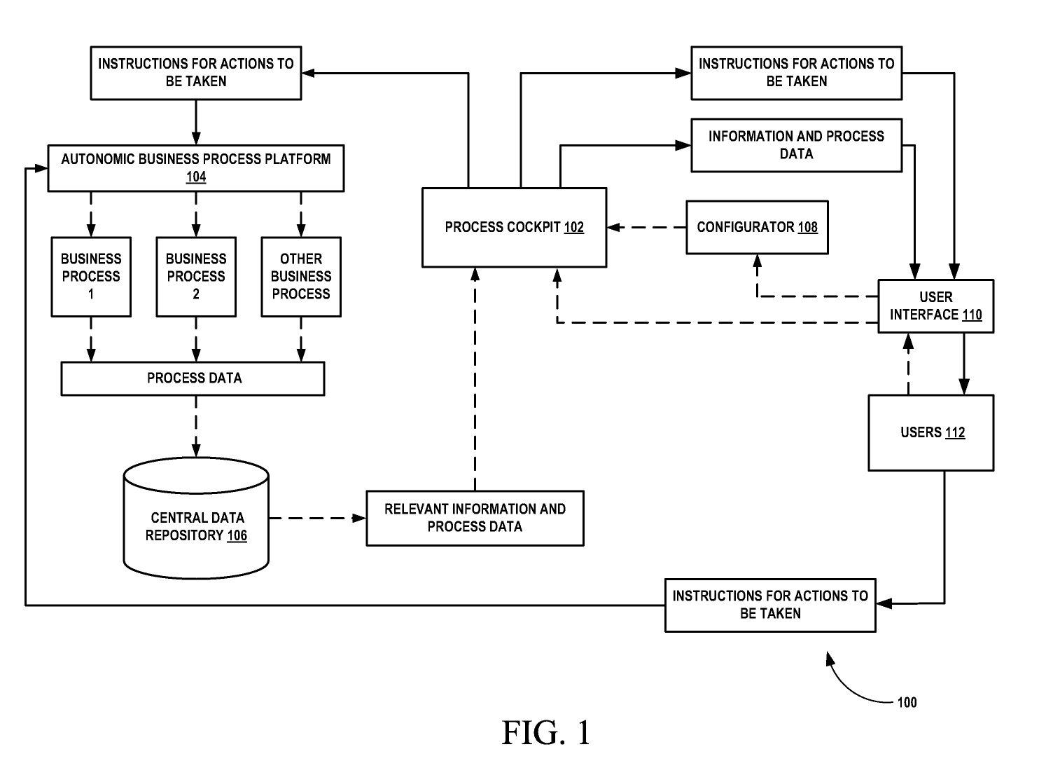

FIG. 1 illustrates a block diagram 100 showing a process cockpit 102 which is used in conjunction with business process outsourcing services, according to one embodiment. Particularly, FIG. 1 illustrates the process cockpit 102 through which various functionalities are enabled by an autonomic business process platform 104.

In some embodiments, the autonomic business process platform 104 enables services and/or functions including but not limited to a demand management, a quality control management and a service level agreement (SLA) management for execution of one or more business processes, e.g., business process 1, business process 2 and other business processes as illustrated in FIG. 1. In one exemplary implementation, the autonomic business process platform 104 provides process data to the process cockpit 102 for generating real time analysis into key business process activities and reports, and also for providing actionable information to make informed decision making. Further, one can envision that any system or method which is capable of providing the process data in real time or near real time to the process cockpit 102 can be used such that the process cockpit 102 generates real time analysis into key business process activities and reports, and provides actionable information to make informed decision making.

It is appreciated that each of the business processes generates process data in real time and stores the process data in a central data repository 106. For example, the process data may be generated at a job level, a process level, etc. Further, the storing and updating of the process data in the central data repository 106 are also performed in real time. In one embodiment, the process cockpit 102 is pre-configured to extract relevant information and the process data from the central data repository 106. In one exemplary implementation, a configurator 108 defines requirements such as business requirements, process requirements, etc., which are configured into the process cockpit 102 through a user interface 110. It is appreciated that the process cockpit 102 uses these configurations to differentiate data relevant to a business process from entire data set of the business process.

Further, the process cockpit 102 is pre-configured with analysis methods and usage requirements that are used to analyze extracted process data and generate insights, reports and information associated with the business processes. In one embodiment, the analysis is performed by the process cockpit 106 in real time and the users 112, e.g., business users, process users, other users, etc. may visualize the analyzed process data in real time. In another embodiment, the analysis performed by the process cockpit 102 may take place as per a schedule, which is configured in the system by the users 112.

Furthermore, as illustrated in FIG. 1, the process cockpit 102 leverages relevant process data captured by the autonomic business process platform 104 during process execution and generates analyzed process data and information using the various analysis methods configured into the process cockpit 102. For example, one of the analysis methods may include analysis of the process data including computation of key performance indicators (KPIs) for business process, such as margin, revenue, customer satisfaction, inventory levels, and other critical parameters. Further, the computed KPIs may be compared with historical data to report abnormal behavior of activities and processes. Such monitoring and analyses of the current and the past data allows the process cockpit 102 to provide actionable information to the users 112 who may then make informed decisions and address problems.

In addition, the analyzed process data is validated and stored in the central data repository 106 in specified formats. In one exemplary embodiment, the process cockpit 102 enables generation of reports, e.g., business performance reports, using the process data captured during the execution of the business process and the analyzed process data. In one embodiment, the reports may be generated based on pre-configured formats as defined in the system and as per schedule defined in the system by the users 112. In an alternate embodiment, the reports may be generated in a format specified by the users 112 and as per query of the users 112. In one exemplary implementation, the process cockpit 102 may be a front end display system of a governance system and provides the users 112 of the system, past as well as current reports on performances of the business processes.

Further, the process cockpit 102 is configured to generate a set of recommended actions based on the analyzed process data, defined business rules and objectives, thus allowing the users 112 of the system to take informed decisions and/or actions. Moreover, the process cockpit 102 is configured to determine, for each recommended action, a related series of interdependent actions and an impact on the related series of interdependent actions based on the selected recommended action. In one example embodiment, the process cockpit 102 displays information extracted from the analyzed process data, the recommended actions, the related series of interdependent actions and the impact on the related series of interdependent actions based on the selected recommended action to the users 112. In accordance with the above-mentioned embodiments, the process cockpit 102 allows a business scenario mapping based on the information extracted from the analyzed process data and the selected recommended action.

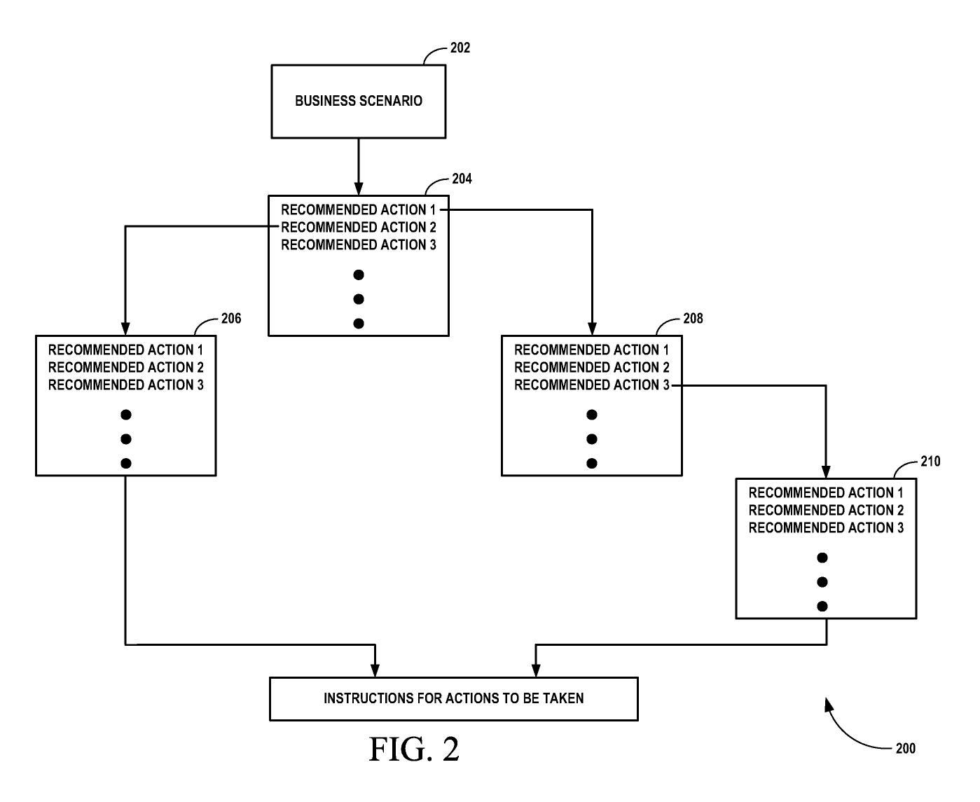

FIG. 2 illustrates a block diagram 200 showing a recommended actions method, according to one embodiment. Particularly, FIG. 2 illustrates a business scenario 202, recommended actions and a related series of interdependent actions that are generated based on the information extracted from the analyzed process data.

In some embodiments, the process cockpit 102 generates multiple sets of recommended actions e.g., as shown in block 204 through block 210 of FIG. 2, associated with the business scenario 202 that may or may not be linked to each other. In other words, a first set of recommended actions may have “n” number of actions which the user 112 of the system implements and the act of selecting one of these recommended actions may lead the user 112 to a related series of “m” number of interdependent actions and so on.

As illustrated in FIG. 2, the block 204 has “n” number of recommended actions which the user 112 of the system may implement and selecting a recommended action 2 from the block 204 leads the user 112 to the block 206 having “m” number of related series of interdependent actions. In a similar vein, selecting a recommended action 1 from the block 204 leads the user 112 to the block 208 having “m” number of related series of interdependent actions. Further, selecting a recommended action 3 from the block 208 leads the user 112 to the block 210 having “o” number of related series of interdependent actions, and so on.

The process cockpit 102 thus provides the user 112 of the system with an entire range of optimal recommended actions which may be performed in a particular business scenario and allows the user 112 to take final decisions for resolving any particular business scenario during the execution of the business processes. Further, for each recommended action, an impact on the related series of interdependent actions is determined based on a particular recommended action. Moreover, the information extracted from the analyzed process data, the related series of interdependent actions, and the impact on the related series of interdependent actions are displayed to the user 112. In one embodiment, the displaying is based on a predetermined user privilege and may be displayed in formats including but not limited to a customizable front page view, an analyzed information and data view and a process data view.

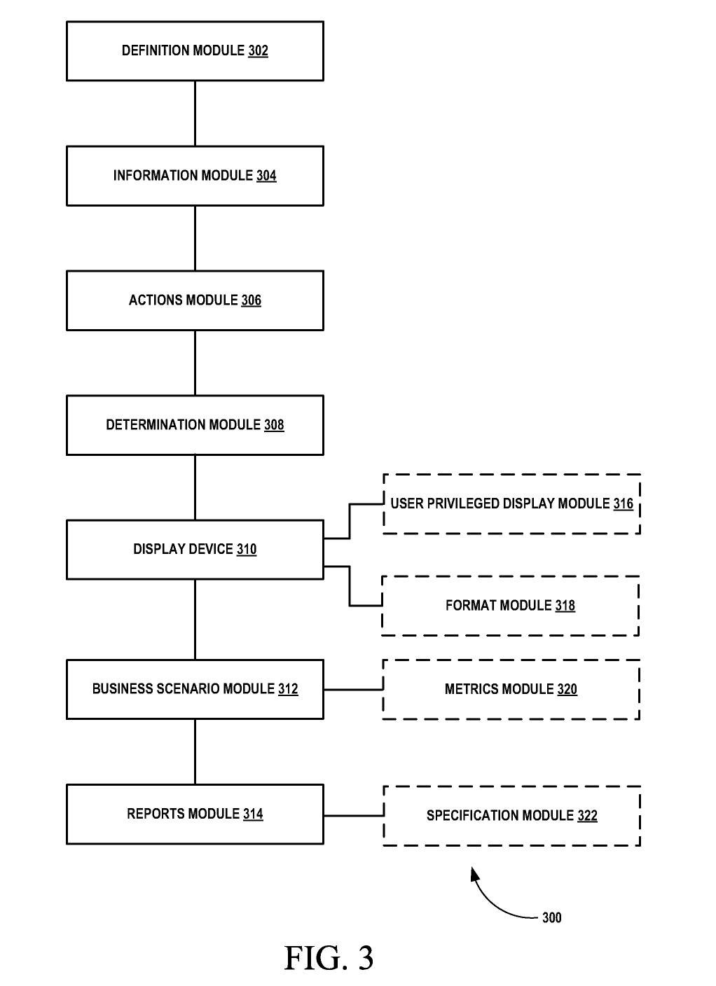

FIG. 3 illustrates various modules associated with the process cockpit 102 of FIG. 1, according to one embodiment. In one embodiment, the process cockpit 102 is used in conjunction with the business process outsourcing services. Particularly, FIG. 3 illustrates a definition module 302, an information module 304, an actions module 306, a determination module 308, a display device 310, a business scenario module 312 and a reports module 314.

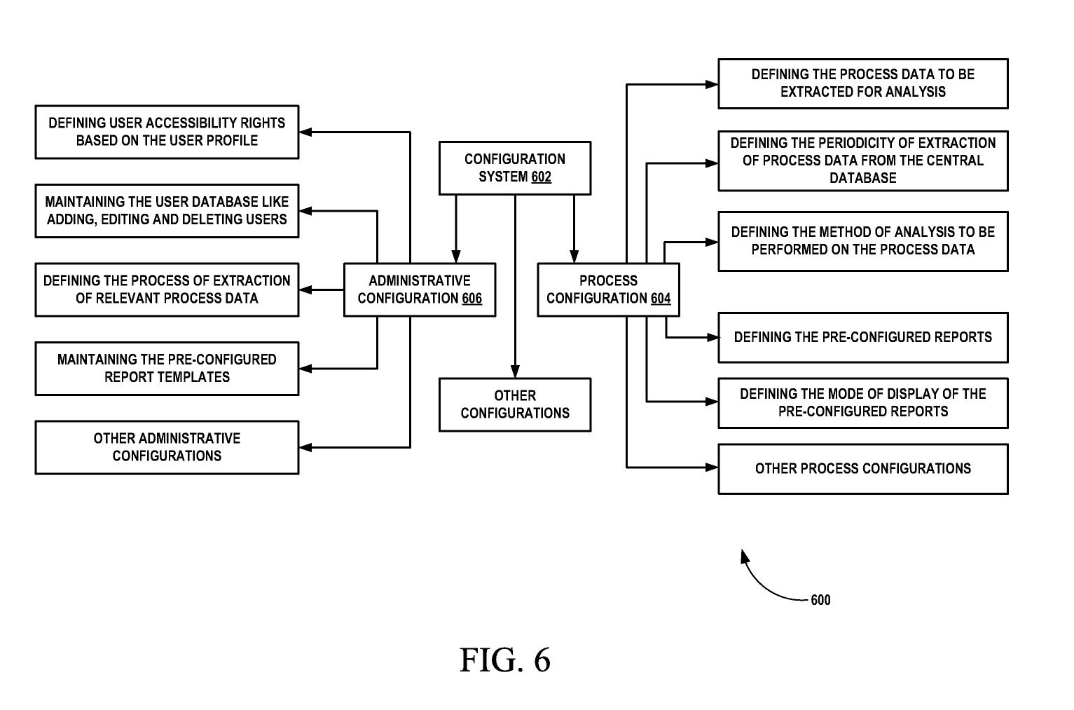

The definition module 302 configures a definition of requirements through a user interface. The information module 304 analyzes extracted process data and extracts information from the analyzed process data based on the requirements, via a computer, e.g., a data processing system 600 of FIG. 6. In some embodiments, the users 112 of the system pre-configures mapping of an analysis method to a query or a report type, i.e., identifying which analysis method is to be used when a certain query or a report is requested by the users 112. Further, the analysis is done in a process point of view as well as a quality point of view. The actions module 306 generates, via the computer, recommended actions based on the information. The determination module 308 determines, for each recommended action, a related series of interdependent actions and an impact on the related series of interdependent actions based on the particular recommended action, via the computer.

The display device 310 displays the information, the recommended actions, the related series of interdependent actions and the impact on the related series of interdependent actions based on the particular recommended action. As shown in FIG. 3, the display device 310 includes a user privileged display module 316 and a format module 318. The user privileged display module 316 displays the information and the recommended actions based on a predetermined user privilege.

The format module 318 displays the information and the recommended actions in a format, e.g., a customizable front page view, an analyzed information and data view, a process data view, etc. Further, the display device 310 acts as a medium through which the users 112 of the system implement decisions and other actions. The business scenario module 312 configures the process cockpit 102 via the computer to allow a business scenario mapping based on the information and a selected recommended action.

Further, as shown in FIG. 3, the business scenario module 312 includes a metrics module 320 to map, based on the information and the selected recommended action, relevant metrics to be calculated and different analysis methods, e.g., including rules and algorithms related to specific business process outsourcing services. The reports module 314 generates reports, via the computer, based on the information. As shown in FIG. 3, the reports module 314 includes a specification module 322 to generate the reports based on a pre-configured format and/or a user specification as per a schedule.

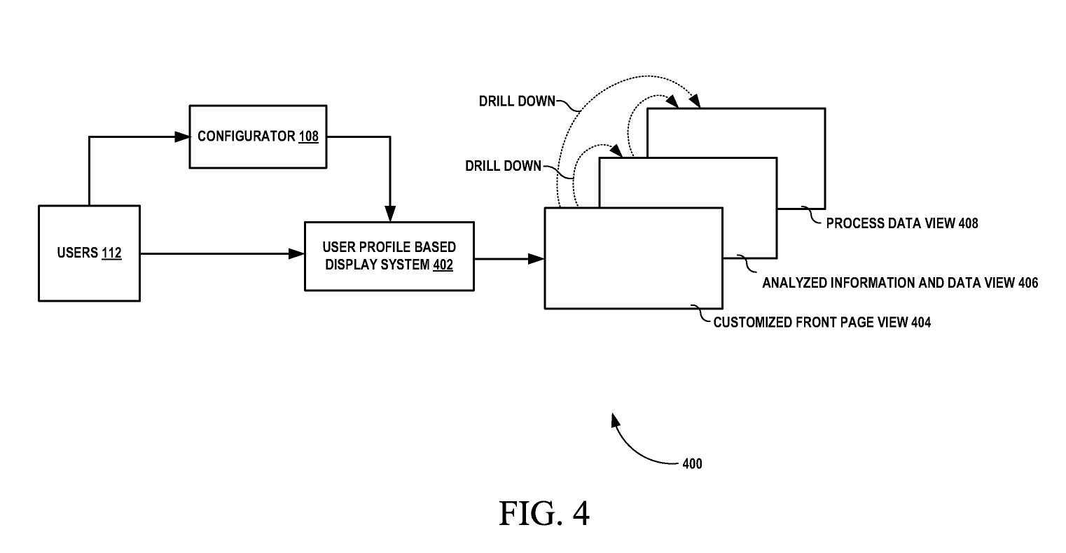

FIG. 4 illustrates a block diagram 400 showing a user profile based display system 402, according to one embodiment. It is appreciated that the user profile based display system 402 is an exemplary embodiment of the user interface 110 of FIG. 1. In some embodiments, the user profile based display system 402 associated with the process cockpit 102 is a primary interface through which the users 112 of the system access the process data, the analyzed process data, the information extracted from the analyzed process data and the recommended actions.

Particularly, FIG. 4 illustrates the configurator 108 for configuring user profiles of the users 112 in the system. In one embodiment, the user profile based display system 402 is sensitive to the user profile of the user 112 who is accessing the process cockpit 102. In other words, the process data, the analyzed process data, the information, and the recommended actions are displayed only if the user profile is authorized to view such information. The depth and range of information visible to each user 112 is based on authorizations given while configuring the user profile in the system.

For example, the user profile based display system 402 displays data and information in three different views, viz., a customizable front page view 404, an analyzed information and data view 406 and a process data view 408. It should be noted that each of the views has a drill down functionality, i.e., from the customizable front page view 404, the user 112 may drill down to the analyzed information and data view 406 or directly drill down to the process data view 408. Also, from the analyzed information and data view 406, the user 112 may drill down to the process data view 408, according to the example embodiment illustrated in FIG. 4.

In one embodiment, the drill down functionality allows the user 112 to visualize only the process data and information which the user 112 is authorized to visualize, evaluate and possibly take decisions. For example, if in a business process operation, there are five areas of operation which are critical out of a total of ten areas of operation, the user 112 may customize the front page to show dashboards for the five areas of operation only. Also, such dashboards are available for all areas of operation defined in the system and the user 112 may have a choice to access all the dashboards which the user 112 has been authorized to access.

Further, in case, out of the five dashboards, two areas of operations need to be evaluated and some decisions are to be taken by the user 112, then, from each of the two dashboards, the user 112 may drill down to see the analyzed information and data view 406. Also, if needed, the user 112 may drill down to the process data view 408 to view actual process data pertaining to the two areas of operation. It is appreciated that the user 112 may directly access the process data, the analyzed process data, the information, and/or recommended actions for all areas to which the user 112 has the authorization.

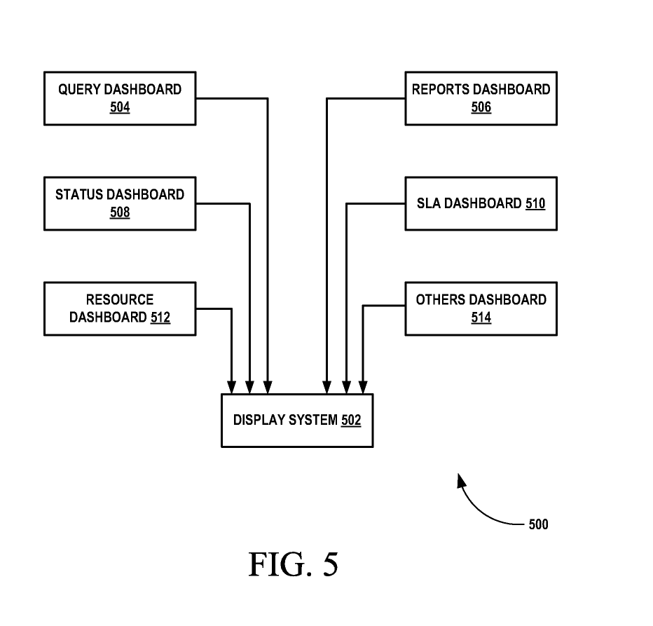

FIG. 5 illustrates a block diagram 500 showing various display system dashboards, according to one embodiment. Particularly, FIG. 5 illustrates a display system 502 which displays among other dashboards 514, a query dashboard 504, a reports dashboard 506, a status dashboard 508, a service level agreement (SLA) dashboard 510 and a resource dashboard 512.

The query dashboard 504 allows the user 112 to query ad-hoc reports. The report dashboard 506 allows the user 112 to view pre-configured reports. The status dashboard 508 allows the user 112 to check status of jobs, job steps, and so on. The SLA dashboard 510 allows the user 112 to keep track of the SLAs. The resource dashboard 512 allows the user 112 to keep track of resources, e.g., track of agents which are part of an operation with respect to which jobs the agents are working on, status of job the agents are working on, process agents that are part of, performance history of the agents, agent availability status, and the like.

FIG. 6 illustrates a block diagram 600 showing a configuration system 602 associated with the process cockpit 102 of FIG. 1, according to one embodiment. In some embodiments, the configuration system 602 allows the user 112 of the system to predefine or configure process and business rules which guide operations of the process cockpit 102. For example, the user 112 of the system may be a business user like an operation head, client representative, etc. or a process user like an administrator of the process, operations manager, process agent, etc. or any other user who needs to interact with the system for smooth operations of the business processes.

In one embodiment, the configuration system 602 allows definition of business requirements, process requirements that are to be configured into the process cockpit 102 though the user interface 110. For example, the business requirements or rules may be defined at a system level, process level, resource level and/or at job level. It should be noted that accessibility to the configuration system 602 may be restrictive and only those who are performing certain roles like an administrator, operations manager, etc. may have accessibility (since the accessibility rights are configured into the system) to defined areas of operation.

As illustrated in FIG. 6, the configuration system 602 allows two types of configuration viz., a process configuration 604 which is related to the operation of the process cockpit 102 and an administrative configuration 606. For example, the process configuration 604 includes defining process data to be extracted for analysis, defining periodicity of extraction of the process data from the central data repository 106, defining analysis methods to be performed on the process data, defining the pre-configured reports, defining mode of display of the pre-configured reports, etc. The administrative configuration 606 includes defining user accessibility rights based on the user profile, maintaining a user database such as adding, editing, deleting users from an accessibility list, defining process of extraction of relevant process data from the central data repository 106, maintaining pre-configured report templates, and so on.

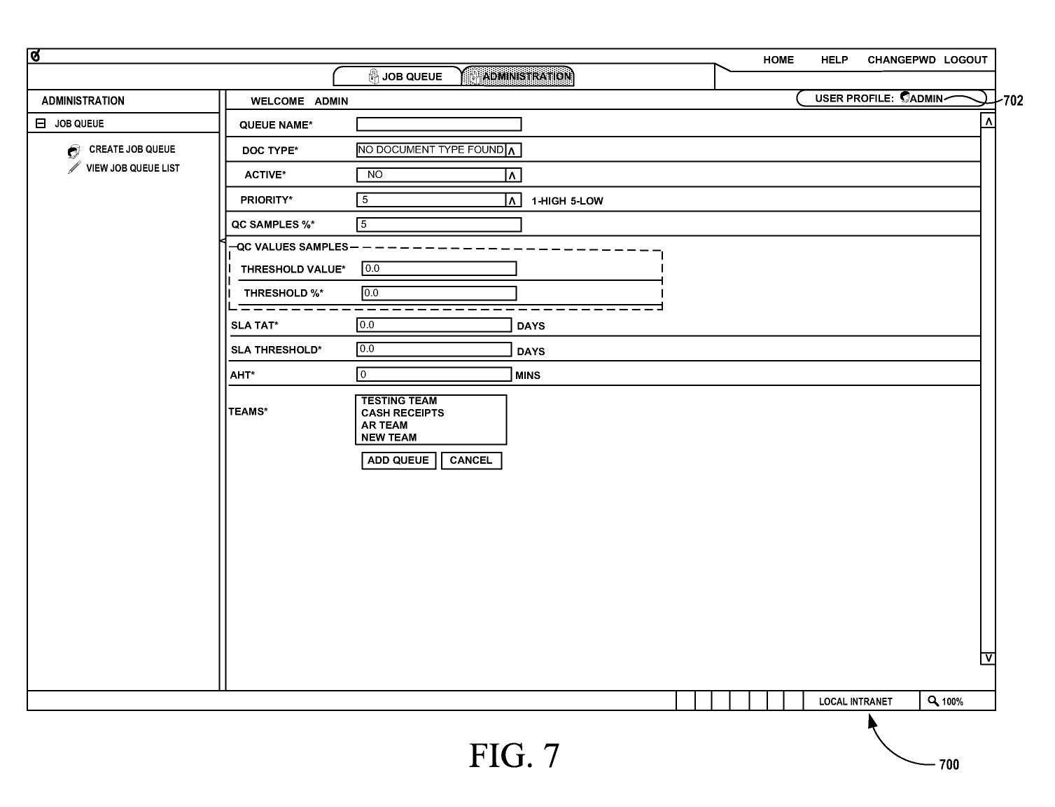

FIG. 7 illustrates an exemplary process configuration screenshot 700, according to one embodiment. Particularly, the process configuration screenshot 700 shows the process configuration 604 configured by an administrator 702. It should be noted that the process configuration 604 may also be configured into the system by any authorized person for example, an operations head, an operation manager, a team lead, etc. As mentioned above, the process configuration 604 includes defining process data to be extracted for analysis, defining periodicity of extraction of the process data from the central data repository 106, defining method of analysis to be performed on the process data, defining pre-configured reports, defining mode of display of the pre-configured reports, etc.

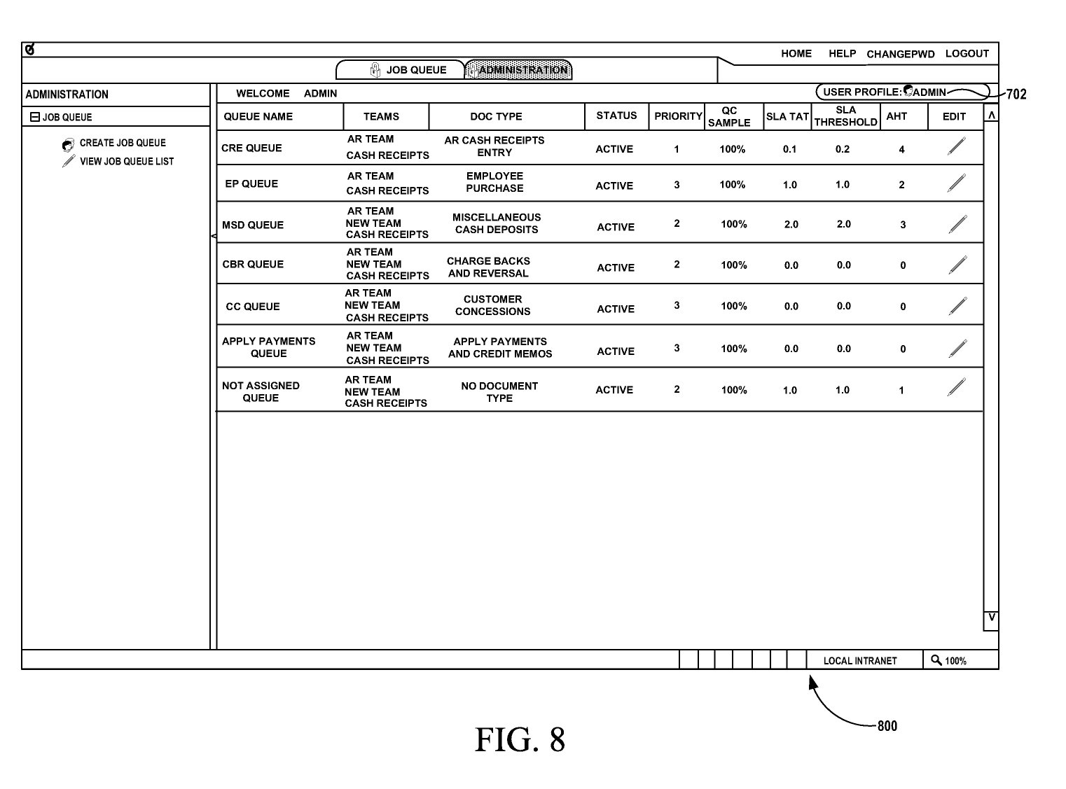

The process configuration 604 may change with time and maturity of the process may lead to changes in the process flow. Further, the process configuration screenshot 700 shows a user interface associated with the administrator 702 whose user profile is authorized to create job queues and view job queue lists. As shown in FIG. 7, the user interface allows the administrator 702 to create the job queue by providing job queue parameters such as a job queue name, document type associated with the job queue, status of the jobs, job priority (high priority or low priority job), QC sample percentage, SLA turn around time, SLA threshold time, average handling time (AHT), teams performing the job, etc. Further, as shown in FIG. 7, the user interface enables the administrator 702 to add the created job queue to a job queue list, e.g., as shown in FIG. 8.

FIG. 8 illustrates another exemplary process configuration screenshot 800, according to one embodiment. Particularly, the process configuration screenshot 800 shows a user interface for reviewing and editing the process configuration, i.e., editing the job queue parameters in case of job queues. In the example embodiment illustrated in FIG. 8, the administrator 702 is allowed to review and edit the job queue parameters which include job queue name, teams, document type, status of the job, priority of the job, QC sample percentage, SLA turn around time, SLA threshold time, AHT, and the like.

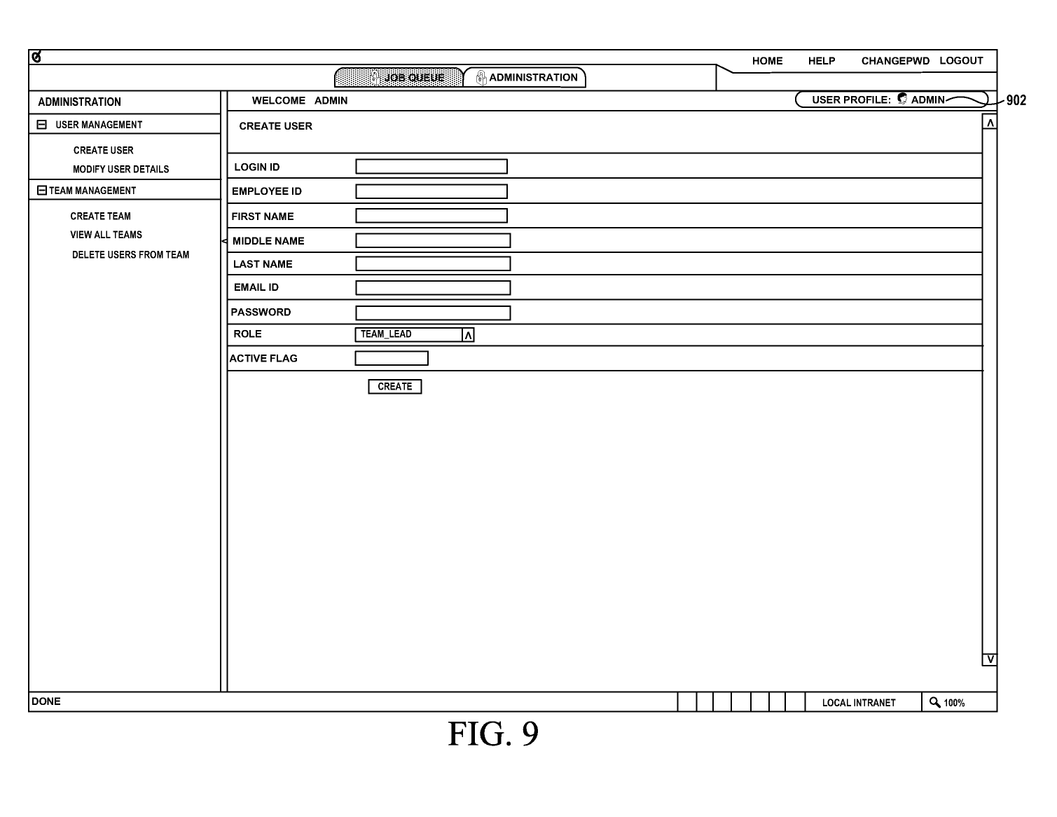

FIG. 9 illustrates an exemplary administrative configuration screenshot 900, according to one embodiment. Particularly, the administrative configuration screenshot 900 shows the administrative configuration 606 that is configured by an administrator 902. As mentioned above, the administrative configuration 606 includes defining user accessibility rights based on the user profile, maintaining user database like adding, editing, deleting users from an accessibility list, defining process of extraction of relevant process data from the central data repository 106, maintaining pre-configured report templates, etc.

In one exemplary implementation, the administrative configuration includes creating users and teams. The administrative configuration screenshot 900 shows a user interface associated with the administrator 902 whose user profile is authorized to create users and teams associated with the business process. As shown in FIG. 9, the user interface enables the administrator 902 to create the users by providing user profile details such as login identifier (ID), employee ID, first name, middle name, last name, email ID, password, role of the user, status of the user, etc.

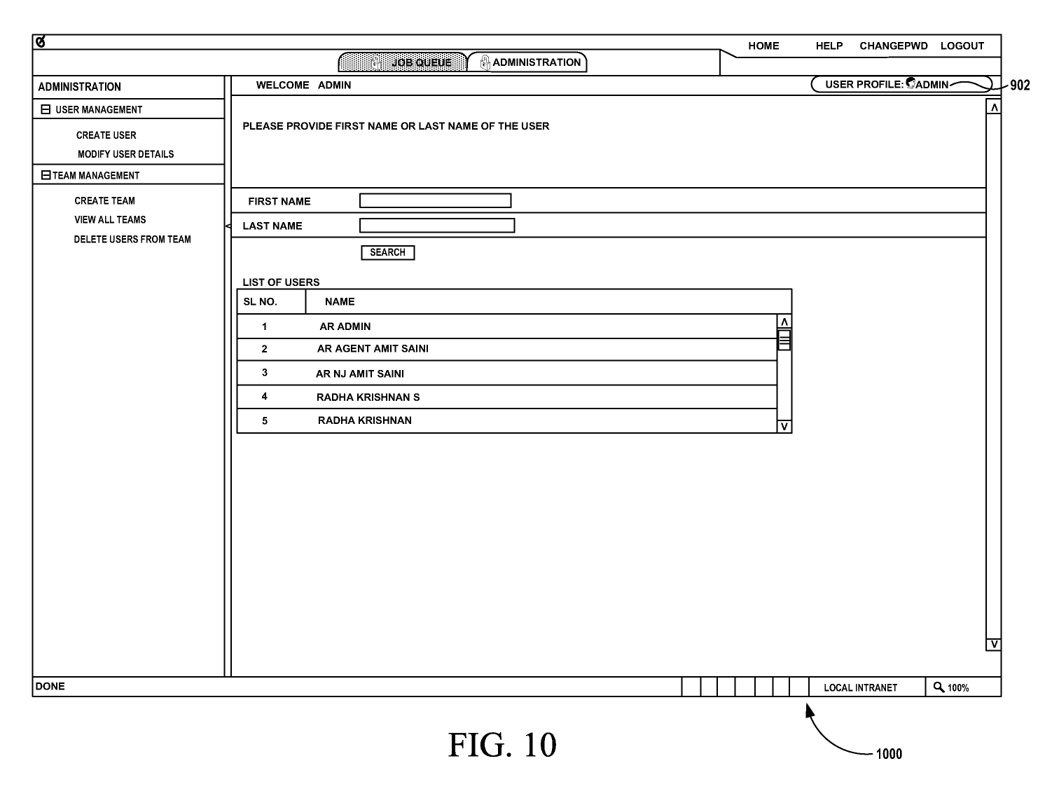

FIG. 10 illustrates another exemplary administrative configuration screenshot 1000, according to one embodiment. Particularly, the administrative configuration screenshot 1000 shows a user interface for deleting one or all the users or the teams. In the example embodiment illustrated in FIG. 10, the administrator 902 provides first name and last name of a user who is to be removed from the team. Further, as shown in FIG. 10, the user interface displays a list of users based on input from the administrator 902 and deletes the users from the team based on the input.

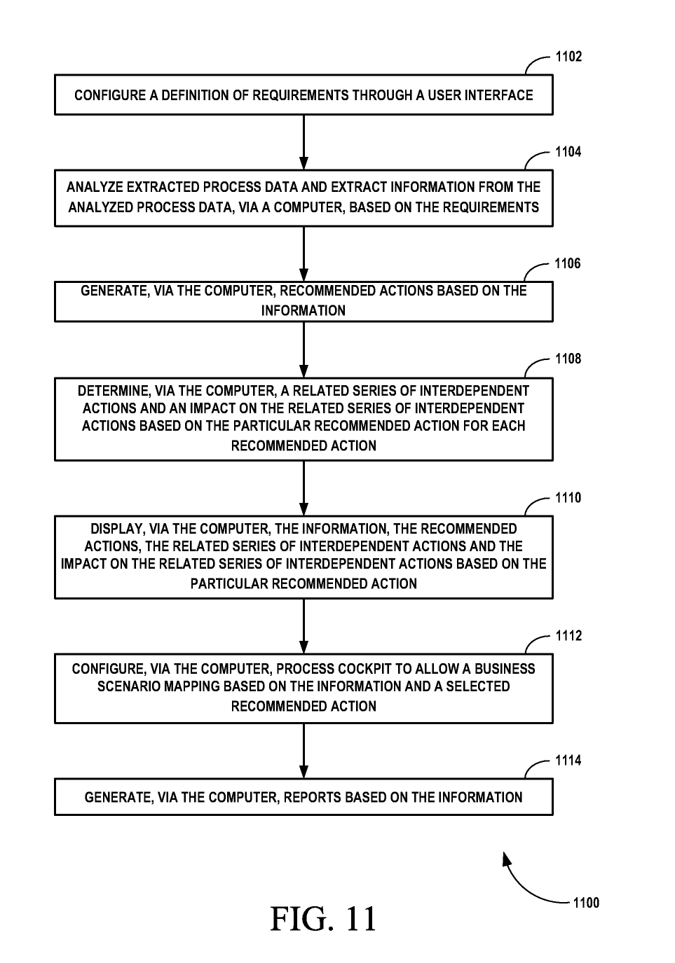

FIG. 11 illustrates a process flow chart 1100 showing a method of providing a process cockpit which is used in conjunction with business process outsourcing services, according to one embodiment. In operation 1102, a definition of requirements is configured through a user interface. In operation 1104, extracted process data is analyzed and information is extracted from the analyzed process data, via a computer, e.g., a data processing system, based on the requirements. In operation 1106, recommended actions are generated, via the computer, based on the information. In operation 1108, for each recommended action, a related series of interdependent actions and an impact on the related series of interdependent actions are determined based on the particular recommended action, via the computer.

In operation 1110, the information, the recommended actions, the related series of interdependent actions and the impact on the related series of interdependent actions based on the particular recommended action are displayed, via the computer. In one embodiment, the information and the recommended actions are displayed based on a predetermined user privilege. Further, the information and the recommended actions are displayed in a format including but not limited to a customizable front page view, an analyzed information and data view and a process data view.

In operation 1112, the process cockpit is configured, via the computer, to allow a business scenario mapping based on the information and a selected recommended action. In some embodiments, the business scenario mapping based on the information and the selected recommended action includes mapping relevant metrics to be calculated and different analysis methods, e.g., including rules and algorithms related to specific business process outsourcing services. In operation 1114, reports, e.g., based on a pre-configured format and/or a user specification as per a schedule, are generated, via the computer, based on the information.

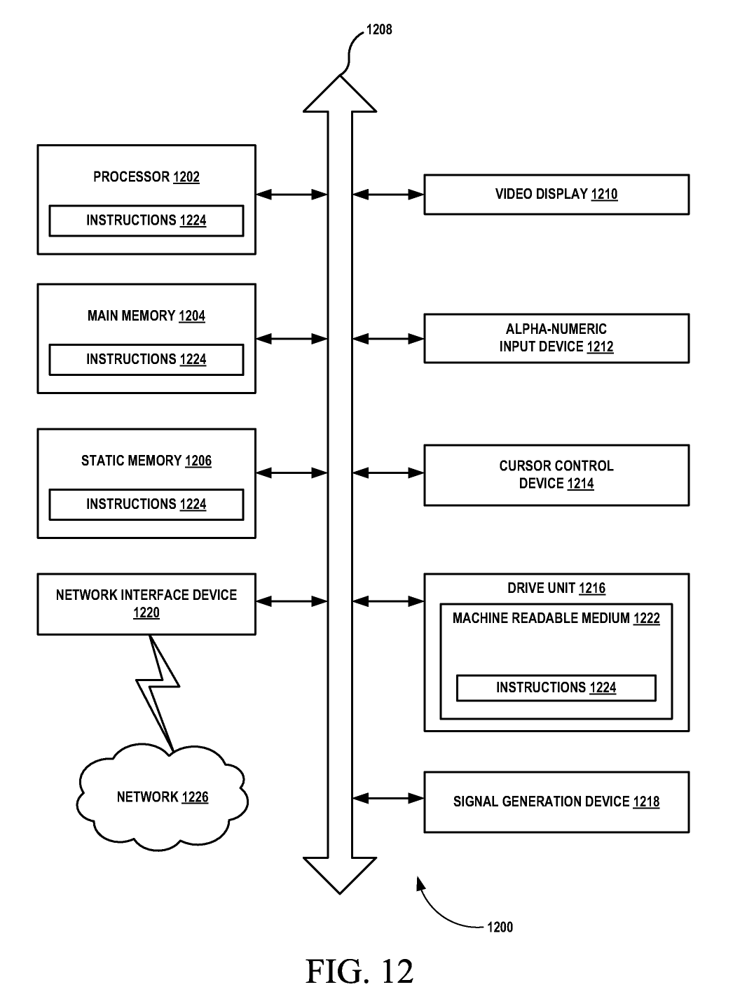

FIG. 12 illustrates a diagrammatic system view 1200 of a data processing system in which any of the embodiments disclosed herein may be performed, according to one embodiment. Particularly, the diagrammatic system view of FIG. 12 illustrates a processor 1202, a main memory 1204, a static memory 1206, a bus 1208, a video display 1210, an alpha-numeric input device 1212, a cursor control device 1214, a drive unit 1216, a signal generation device 1218, a network interface device 1220, a machine readable medium 1222, instructions 1224 and a network 1226.

The diagrammatic system view 1200 may indicate a personal computer and/or a data processing system in which one or more operations disclosed herein are performed. The processor 1202 may be a microprocessor, a state machine, an application specific integrated circuit, a field programmable gate array, etc. The main memory 1204 may be a dynamic random access memory and/or a primary memory of a computer system. The static memory 1206 may be a hard drive, a flash drive, and/or other memory information associated with the data processing system.

The bus 1208 may be an interconnection between various circuits and/or structures of the data processing system. The video display 1210 may provide graphical representation of information on the data processing system. The alpha-numeric input device 1212 may be a keypad, keyboard and/or any other input device of text, e.g., a special device to aid the physically handicapped. The cursor control device 1214 may be a pointing device such as a mouse. The drive unit 1216 may be a hard drive, a storage system, and/or other longer term storage subsystem.

The signal generation device 1218 may be a BIOS and/or a functional operating system of the data processing system. The network interface device 1220 may perform interface functions, e.g., code conversion, protocol conversion, and/or buffering required for communications to and from the network 1226 between a number of independent devices, e.g., of varying protocols. The machine readable medium 1222 may provide instructions on which any of the methods disclosed herein may be performed. The instructions 1224 may provide source code and/or data code to the processor 1202 to enable any one or more operations disclosed herein.

For example, a storage medium having instructions, that when executed by a computing platform, result in execution of a method of providing the process cockpit 102 used in conjunction with business process outsourcing services, the method includes configuring a definition of requirements through a user interface, based on the requirements, analyzing extracted process data and extracting information from the analyzed process data and generating recommended actions based on the information.

The storage medium also has instructions to determine, for each recommended action, a related series of interdependent actions and an impact on the related series of interdependent actions based on the particular recommended action and display the information, the recommended actions, the related series of interdependent actions and the impact on the related series of interdependent actions based on the particular recommended action. In one embodiment, displaying the information and the recommended actions includes displaying the information and the recommended actions based on a predetermined user privilege. Further, the information and the recommended actions are displayed in a format including but not limited to a customizable front page view, an analyzed information and data view and a process data view.

Further, the storage medium has instructions to configure the process cockpit 102 to allow a business scenario mapping based on the information and a selected recommended action. In some embodiments, the business scenario mapping based on the information and the selected recommended action includes mapping, based on the information and the selected recommended action, relevant metrics to be calculated and different analysis methods including rules and algorithms related to specific business process outsourcing services. Also, the storage medium may have instructions to generate reports based on the information.

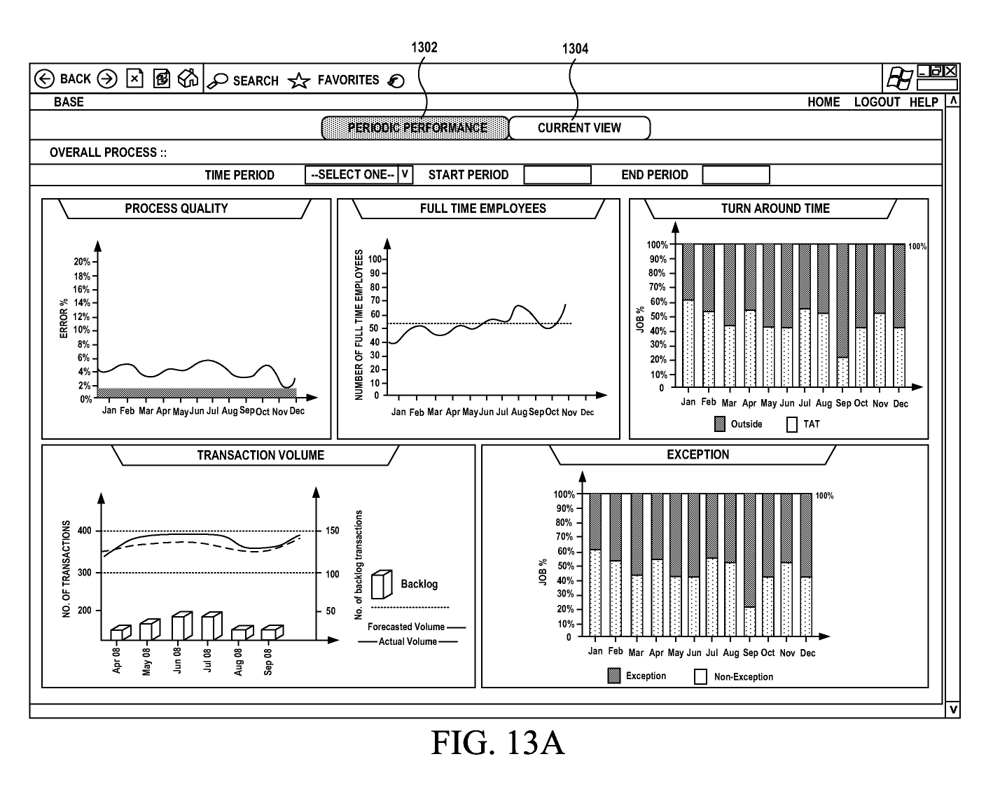

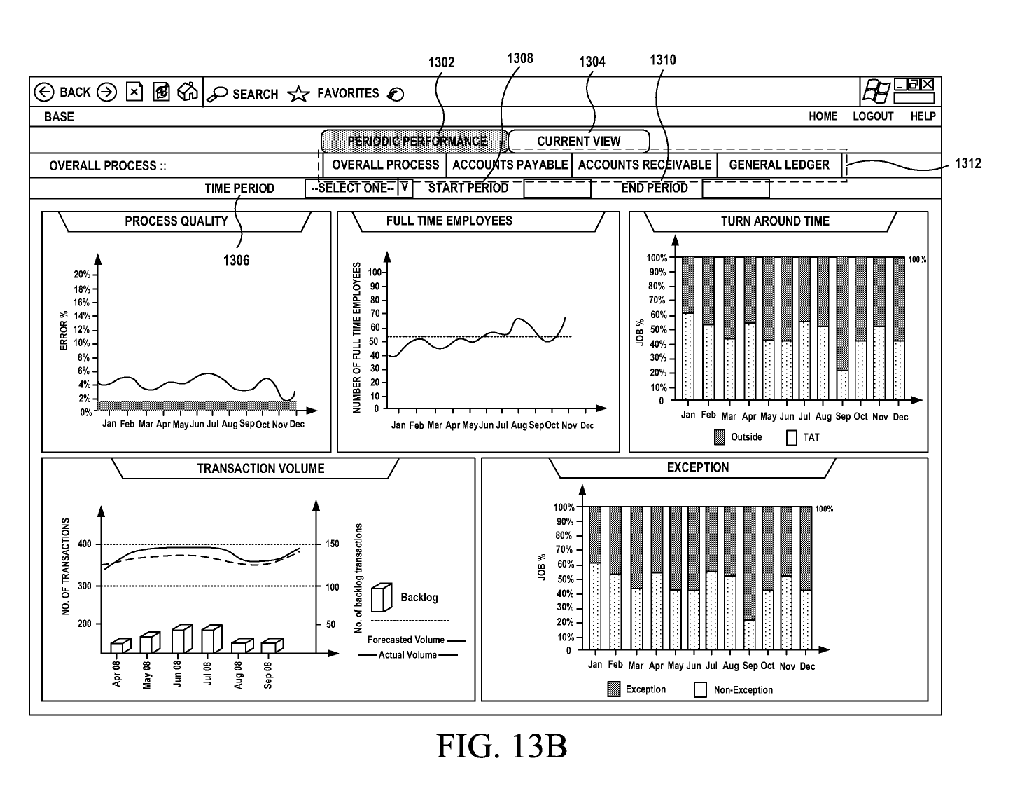

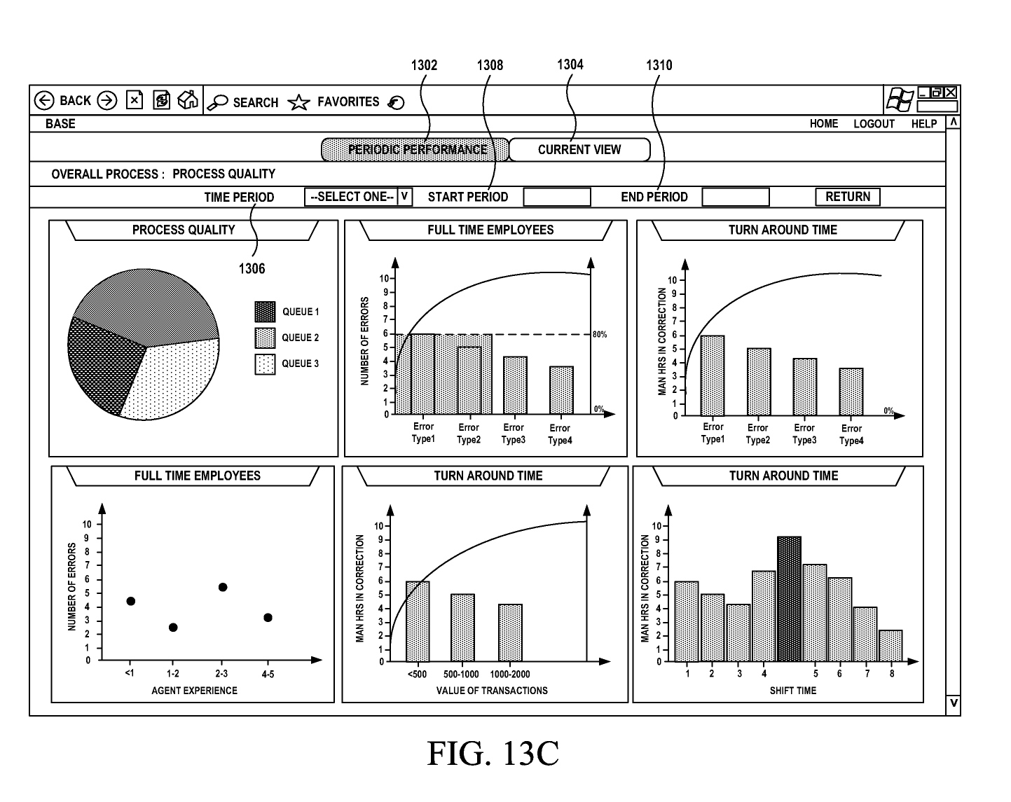

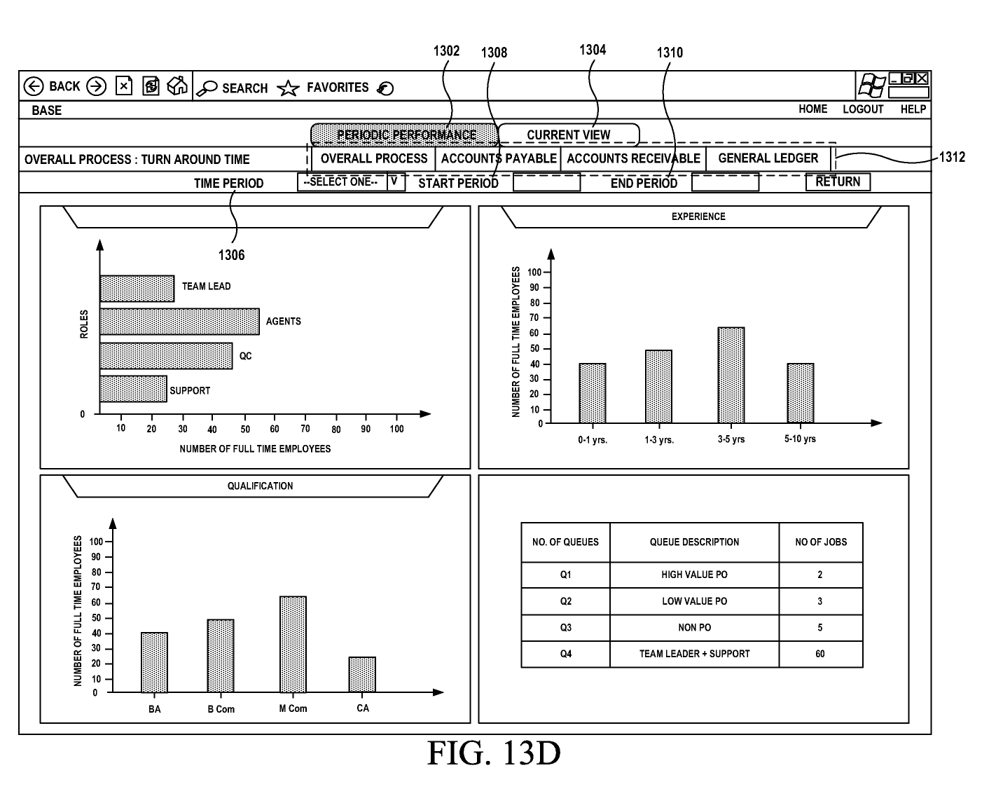

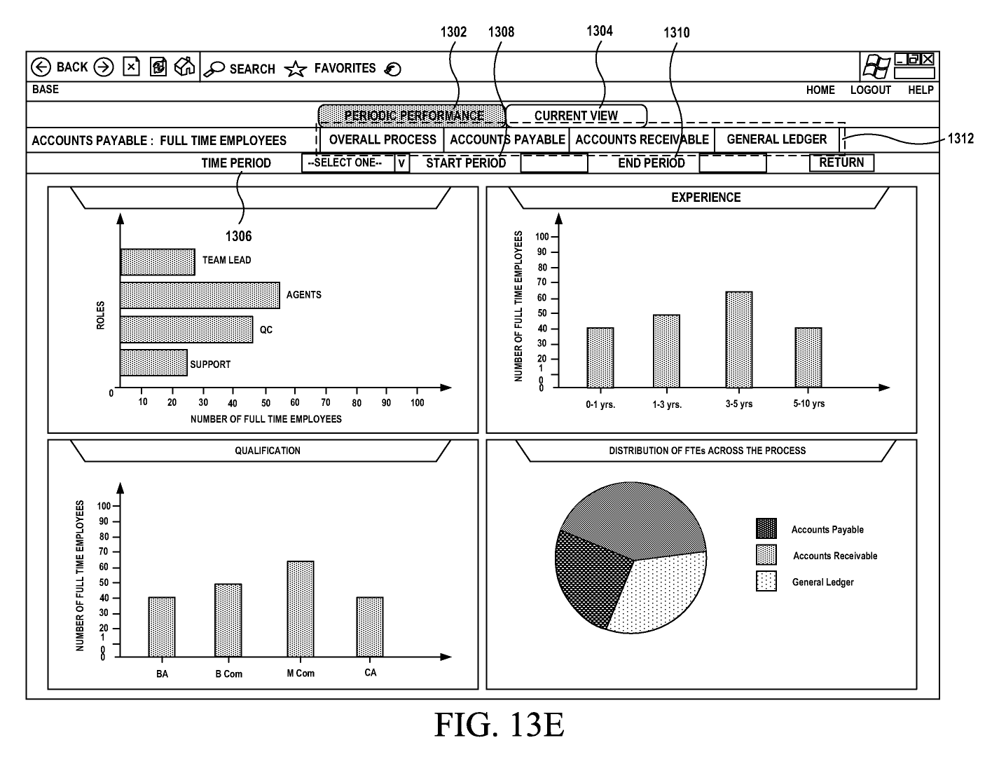

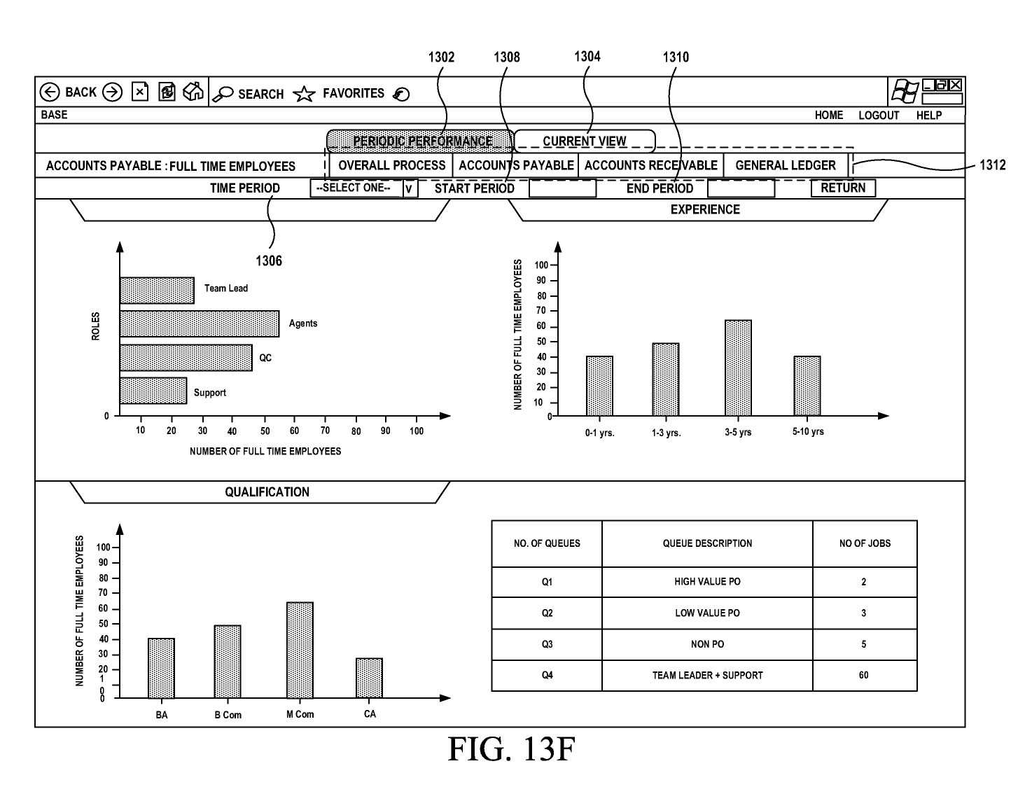

FIGS. 13A-13F illustrate exemplary screenshots showing automated data analysis through the process cockpit 102, according to one embodiment. It is appreciated that various functionalities displayed by the process cockpit 102 are sensitive to the user 112 who is accessing the process cockpit 102. In other words, the process data, the analyzed process data and the information are displayed only if the user profile is authorized to view such information. Further, the depth of information visible to each user 112 is based on authorizations given to the users 112 while configuring the user profile in the system. Furthermore, the process cockpit 102 enables the user 112 to select main data fields from a list to obtain a customized front page view.

In the example embodiment illustrated in FIG. 13A, the customized front page view for the process cockpit 102 displays periodic performance reports with fields such as process quality, full time employees, turn around time, transaction volume and exception. As shown in FIG. 13A, the periodic performance tab 1302 enables the user 112 to visualize the performance reports for a period while the current view tab 1304 enables the user 112 to visualize current status of the process associated with the process cockpit 102. Further, it can be seen from FIG. 13A that, the user 112 may visualize information related to performance reports for a desired time period such as monthly, quarterly, yearly, etc. through a time period field 1306.

Also, the time period for which the information is required may be customized by providing a start period through a start period field 1308 and an end period through an end period field 1310 such that the user 112 visualizes the performance reports between the given time period. Furthermore, the process cockpit 102 allows the users 112 to visualize performance reports of all the processes combined or for each process individually. As illustrated in FIG. 13B, within the periodic performance tab 1302, there are tabs 1312 provided to display reports for overall process, accounts payable, accounts receivable and general ledger process. It is appreciated that, for each type of process, a set of performance indicators may be displayed.

It is also appreciated that the process cockpit 102 enables a drill down functionality such that the user 112 may drill down to the analyzed information and data view from the customized front page view. In the example embodiment illustrated in FIG. 13C, an analyzed information and data view is displayed which is drilled down, e.g., by selecting the process quality field of FIG. 13B. Particularly, FIG. 13C illustrates information related to process quality for overall processes such as queue-wise error and the like. In one example embodiment, the detailed information enables the user 112 to identify a source of error as well as reasons for fluctuations in the process quality.

Further, it can be seen from FIG. 13D that, the user may drill down for any particular process. In the example embodiment illustrated in FIG. 13D, the screenshot shows an analyzed information and data view for an account payable process related to turnaround time. In some embodiments, the process cockpit 102 enables the user 112 to directly drill down to the process data view from the customized front page view. For example, from the overall process, the user may directly drill down to any particular process like the accounts payable process for a particular data field such as number of full time employees. In one example embodiment, information related to number of full time employees for the overall process is displayed in FIG. 13E. Further, if an accounts payable tab is selected by the user 112 from the tab 1312 in FIG. 13E, a detailed information view related to full time employees in accounts payable process for a given time period is displayed, as illustrated in FIG. 13F.

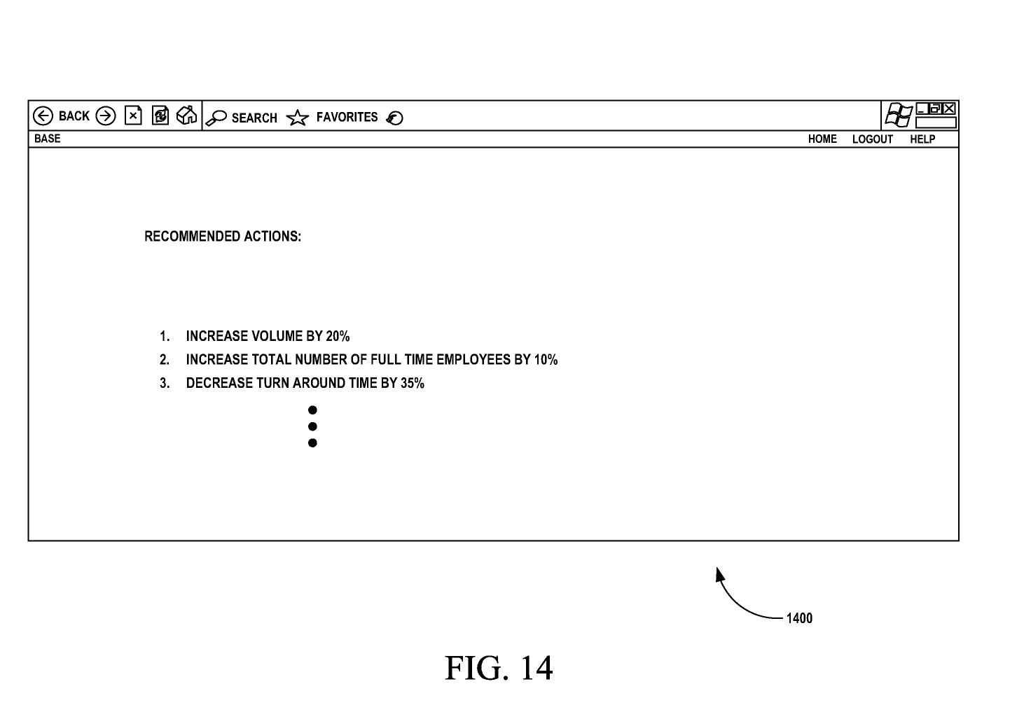

FIG. 14 illustrates an exemplary screenshot 1400 showing recommended actions generated to resolve any particular business scenario in the autonomic business process platform 104, according to one embodiment. In one exemplary implementation, the process cockpit 102 is configured to generate a set of recommended actions based on analyzed process data, defined business rules and objectives. It is appreciated that the analyzed process data is generated during process execution in the autonomic business process platform 104. In one embodiment, the recommended actions allow the users 112 of the system to take informed decisions and/or actions to address the particular business scenario.

In the example embodiment illustrated in FIG. 14, the recommended actions include increasing transaction volume by 20%, increasing total number of full time employees by 10%, decreasing turn around time by 35% and so on.

The above-described functionality of the process cockpit is used in conjunction with business process outsourcing services and provides real-time insight into business processes being operated using an autonomic business process platform. The above-described process cockpit allows a user, e.g., a process agent, an operations manager, an outsourcing business manager and a client representative, etc. to have easy accessibility to information being generated within the outsourced business process and enhances visibility into the process data giving the user valuable insight into the business process. The above-described process cockpit also gives the user a set of recommended actions to be taken for a particular scenario in the operation of the business process which essentially build-upon the actual data of the process along with the analyzed processed data.

It will be appreciated that the various embodiments discussed herein may not be the same embodiment, and may be grouped into various other embodiments not explicitly disclosed herein. In addition, it will be appreciated that the various operations, processes, and methods disclosed herein may be embodied in a machine-readable medium and/or a machine accessible medium compatible with a data processing system, e.g., a computer system, and may be performed in any order, e.g., including using means for achieving the various operations. Accordingly, the specification and drawings are to be regarded in an illustrative rather than a restrictive sense.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry, e.g., complementary metal oxide semiconductor (CMOS) based logic circuitry, firmware, software and/or any combination of hardware, firmware, and/or software, e.g., embodied in a machine readable medium. For example, the various electrical structure and methods may be embodied using transistors, logic gates, and electrical circuits, e.g., application specific integrated circuitry (ASIC).

What is claimed is:

1. A method of providing an automated data analysis and recommendation comprising:
configuring a definition of requirements through a user interface;
analyzing extracted process data and extracting information from the analyzed process data based on the requirements, via a computer;
generating, via a computer, recommended actions based on the information;
determining, via a computer, a related series of interdependent actions and at least one impact on the related series of interdependent actions based on the particular recommended action for each recommended action;
displaying, via a computer, the information, the recommended actions, the related series of interdependent actions and the at least one impact on the related series of interdependent actions based on the particular recommended action; and
configuring, via a computer, the process cockpit to allow at least one business scenario mapping based on the information and a selected recommended action.

2. The method of claim 1, wherein the displaying the information and the recommended actions comprises:
displaying the information and the recommended actions based on a predetermined user privilege.

3. The method of claim 1, wherein the displaying the information and the recommended actions comprises:
displaying the information and the recommended actions in a format selected from the group consisting essentially of a customizable front page view, an analyzed information and data view, and a process data view.

4. The method of claim 1, wherein the at least one business scenario mapping based on the information and the selected recommended action comprises:
mapping, based on the information and the selected recommended action, relevant metrics to be calculated and different analysis methods selected from the group consisting essentially of rules and algorithms related to specific business process outsourcing services.

5. The method of claim 1, further comprising:
generating, via a computer, reports based on the information.

6. The method of claim 5, wherein the generating reports based on the information comprises:
generating the reports based on at least one of a pre-configured format and a user specification as per a schedule.

7. The method of claim 1, wherein the process cockpit is used in conjunction with business process outsourcing services.

8. The method of claim 1 in a form of a machine-readable medium embodying a set of instructions that, when executed by a machine, causes the machine to perform the method of claim 1.

9. A system of providing an automated data analysis and recommendation comprising:
a definition module to configure, via a computer, a definition of requirements through a user interface;
an information module to analyze, via a computer, extracted process data and extract information from the analyzed process data based on the requirements;
an actions module to generate, via a computer, recommended actions based on the information;
a determination module to determine, via a computer, a related series of interdependent actions and at least one impact on the related series of interdependent actions based on the particular recommended action for each recommended action;
a display device to display the information, the recommended actions, the related series of interdependent actions and the at least one impact on the related series of interdependent actions based on the particular recommended action; and
a business scenario module to configure, via a computer, the process cockpit to allow at least one business scenario mapping based on the information and a selected recommended action.

10. The system of claim 9, wherein the display device comprises:
a user privileged display module to display the information and the recommended actions based on a predetermined user privilege.

11. The system of claim 9, wherein the display device comprises:
a format module to display the information and the recommended actions in a format selected from the group consisting essentially of a customizable front page view, an analyzed information and data view, and a process data view.

12. The system of claim 9, wherein the business scenario module comprises:
a metrics module to map, based on the information and the selected recommended action, relevant metrics to be calculated and different analysis methods selected from the group consisting essentially of rules and algorithms related to specific business process outsourcing services.

13. The system of claim 9, further comprising:
a reports module to generate, via a computer, reports based on the information.

14. The system of claim 13, wherein the reports module comprises:
a specification module to generate the reports based on at least one of a pre-configured format and a user specification as per a schedule.

15. The system of claim 9, wherein the process cockpit is used in conjunction with business process outsourcing services.

16. An article, comprising:
a storage medium having instructions, that when executed by a computing platform, result in execution of a method of providing an automated data analysis and recommendation used in conjunction with business process outsourcing services comprising:
configuring a definition of requirements through a user interface;
based on the requirements, analyzing extracted process data and extracting information from the analyzed process data;
generating recommended actions based on the information;
determining, for each recommended action, a related series of interdependent actions and at least one impact on the related series of interdependent actions based on the particular recommended action;
displaying the information, the recommended actions, the related series of interdependent actions and the at least one impact on the related series of interdependent actions based on the particular recommended action; and
configuring the process cockpit to allow at least one business scenario mapping based on the information and a selected recommended action.

17. The article of claim 16, wherein the displaying the information and the recommended actions comprises:
displaying the information and the recommended actions based on a predetermined user privilege.

18. The article of claim 16, wherein the displaying the information and the recommended actions comprises:
displaying the information and the recommended actions in a format selected from the group consisting essentially of a customizable front page view, an analyzed information and data view, and a process data view.

19. The article of claim 16, wherein the at least one business scenario mapping based on the information and the selected recommended action comprises:
mapping, based on the information and the selected recommended action, relevant metrics to be calculated and different analysis methods selected from the group consisting essentially of rules and algorithms related to specific business process outsourcing services.

20. The article of claim 16, further comprising:
generating reports based on the information.
